(19) United States
(12) Patent Application Publication
(10) Pub. No.: US 2015/0172441 A1
(43) Pub. Date: Jun. 18, 2015

(54) COMMUNICATION MANAGEMENT FOR PERIODS OF INCONVENIENCE ON WEARABLE DEVICES

(71) Applicant: Imad Samhat, San Francisco, CA (US)

(72) Inventor: Imad Samhat, San Francisco, CA (US)

(73) Assignee: ALIPHCOM, San Francisco, CA (US)

(21) Appl. No.: 14/105,119

(22) Filed: Dec. 12, 2013

(51) Int. Cl. H04M 1/725

(52) U.S. Cl. CPC H04M 1/72563

(57) ABSTRACT

Techniques for communication management for periods of inconvenience on wearable devices using sensory input are described. Various embodiments relate generally to wearable electrical and electronic hardware, computer software, human-computing interfaces, wired and wireless network communications, telecommunications, data processing, and computing devices. Disclosed are techniques for receiving input from one or more sensors coupled to a wearable device, determining pattern data associated with an incoming call based on the input, determining the incoming call is received in a period of inconvenience by comparing the pattern data against data representing one or more inconvenience patterns, and initiating execution of a moderation operation associated with the period of inconvenience to modify an operation of the wearable device. In some embodiments, the input includes a local time. In some embodiments, the pattern data includes data representing an activity. In some embodiments, the moderation operation suppresses a ringing of the wearable device. In some embodiments, the moderation operation transmits a message to the caller indicating the incoming call was received in a period of inconvenience.

### FIELD

Various embodiments relate generally to wearable electrical and electronic hardware, computer software, human-computing interfaces, wired and wireless network communications, telecommunications, data processing, and computing devices. More specifically, disclosed are techniques for detecting a period of inconvenience of a called party on an incoming call to a wearable device.

### BACKGROUND

With the advent of communications devices in smaller personal and/or portable form factors, users may be reached on wearable communications devices virtually anytime, anywhere. However, users may not want to be reached during a certain time or when they are engaged in a certain activity. Conventional devices typically allow users to completely turn off the devices to block off all incoming calls. Some conventional devices further allow the caller to leave a voicemail or other message. However, when the communications device is turned off, the caller is not able to place the call, and the user cannot respond to the call.

Some conventional solutions may allow users to set the communications device to “silent” or “vibration” mode without turning off the communications device. That way, the caller is able to place the call, and the user may choose to respond to the incoming call. However, when a communications device is set to “silent” or “vibration” mode, the user generally easily misses the notification of the call. Moreover, it does not make any distinctions between urgent and important calls from other calls.

Thus, what is needed is a solution for communication management for periods of inconvenience on wearable devices without the limitations of conventional techniques.

### BRIEF DESCRIPTION OF THE DRAWINGS

Various embodiments or examples (“examples”) are disclosed in the following detailed description and the accompanying drawings:

FIG. 1 illustrates an exemplary wearable device with an inconvenience manager in a network, according to some examples;

FIG. 2 illustrates an exemplary system for an inconvenience manager using sensory input;

FIG. 3 illustrates sensors for use with an exemplary wearable device with an inconvenience manager;

FIG. 4 illustrates an application architecture for an exemplary wearable device with an inconvenience manager;

FIG. 5A illustrates an exemplary process for an inconvenience manager using a local time;

FIG. 5B illustrates another exemplary process for an inconvenience manager using sensory input;

FIG. 6 illustrates a block diagram for an exemplary wearable device with an inconvenience manager; and

FIG. 7 illustrates an exemplary computer system suitable for use with an inconvenience manager.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

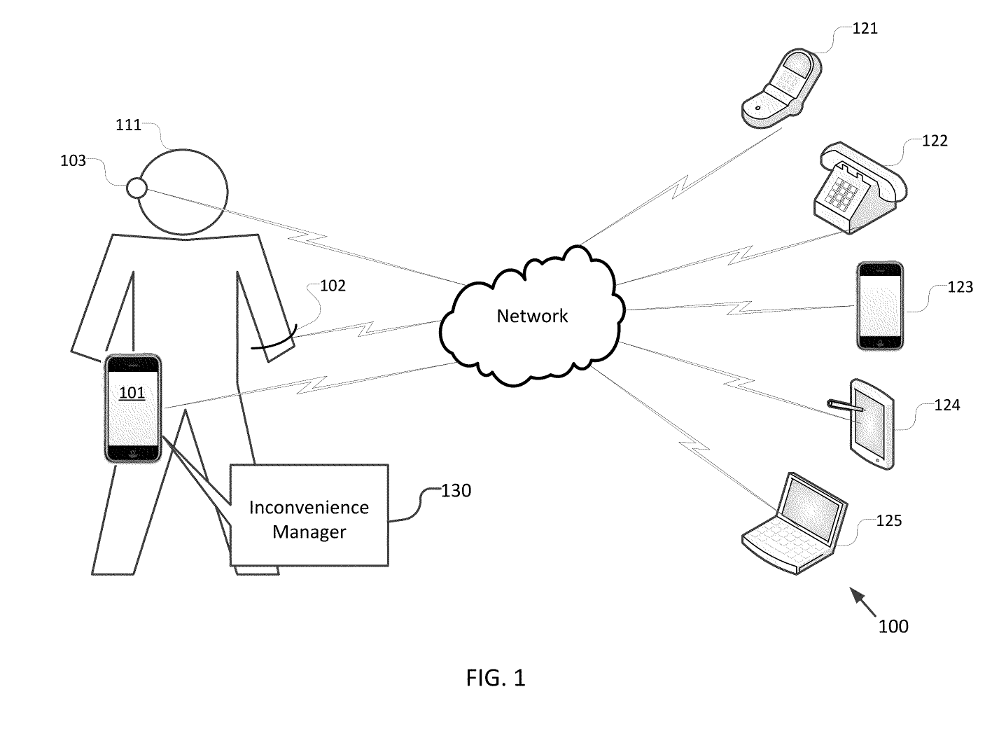

FIG. 1 illustrates an exemplary wearable device with an inconvenience manager in a network, according to some examples. Here, diagram 100 includes wearable devices 101-103, an inconvenience manager 130, a cell phone 121, a telephone 122, a smartphone 123, a tablet 124, a computer 125, and a user or called party 111. Wearable devices 101-103 may be worn around an arm, leg, ear, or other bodily appendage or feature, or portable in a user's hand, pocket, bag or other carrying case. As an example, wearable device 101 is a smartphone, wearable device 102 is a data-capable strapband, and wearable device 103 is a headset. Other wearable devices such as a cell phone, tablet, telephone, laptop or other computing device may be used. Wearable devices 101-103 are used to directly or indirectly establish communication links over a network. The network may be a wired, wireless, public, private, secure or other network that allows the exchange of data between computing devices or computers, and the network may use one or more data communication protocols (e.g., IEEE 802.11a/b/g/n (WiFi), WiMax, ANT™, ZigBee®, Bluetooth®, Near Field Communications (NFC), 3G, 4G, telecommunications, internet protocols, and others). In still other examples, wearable devices 101-103 may be used differently.

Wearable devices 101-103 may receive an incoming call over a network from a calling party or caller using a cell phone 121, a telephone 122, a smartphone 123, a tablet 124, a computer 125 or another device. As described above, the data communication link may be established through a telecommunications network, internet protocol network, WiFi, Bluetooth, NFC or other network or protocol. The incoming call may include data representing voice or sound, such as a telephone call, voice-over-IP call, or voice message, and may generally trigger a notification signal of wearable devices 101-103, such as a ringing, vibration, blinking, push notification or other notification. In other examples, the incoming call may be a text message or other data message. An inconvenience manager 130 integrated, installed or otherwise implemented in hardware or software, or both, on wearable devices 101-103 may be used to determine whether the incoming call is received at a time that is inconvenient for called party 111 to be disturbed or interrupted by or otherwise notified by the incoming call. If so, inconvenience manager 130 may initiate execution of a moderation operation. A moderation operation is an operation that delays, interferes, postpones, terminates, suppresses, cancels, moderates or otherwise alters the notification signal to be less disruptive for the called party. The moderation operation may further interact with the caller to perform further operations, such as sending a message notifying the caller that the incoming call was received during a period of inconvenience. Inconvenience manager 130 is described in more detail below.

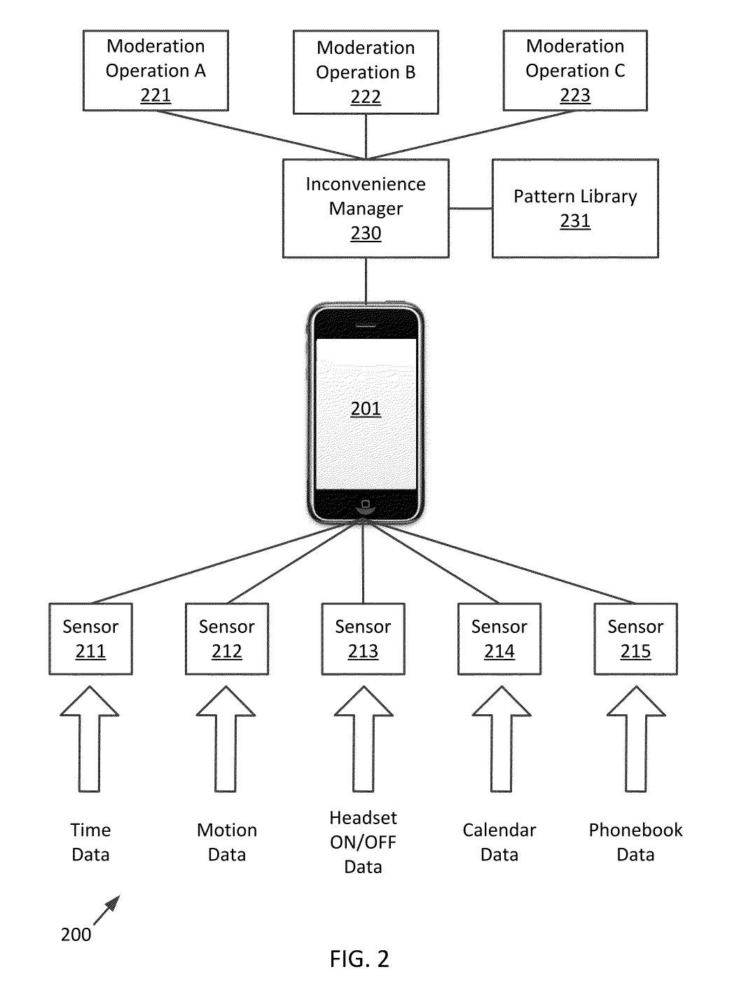

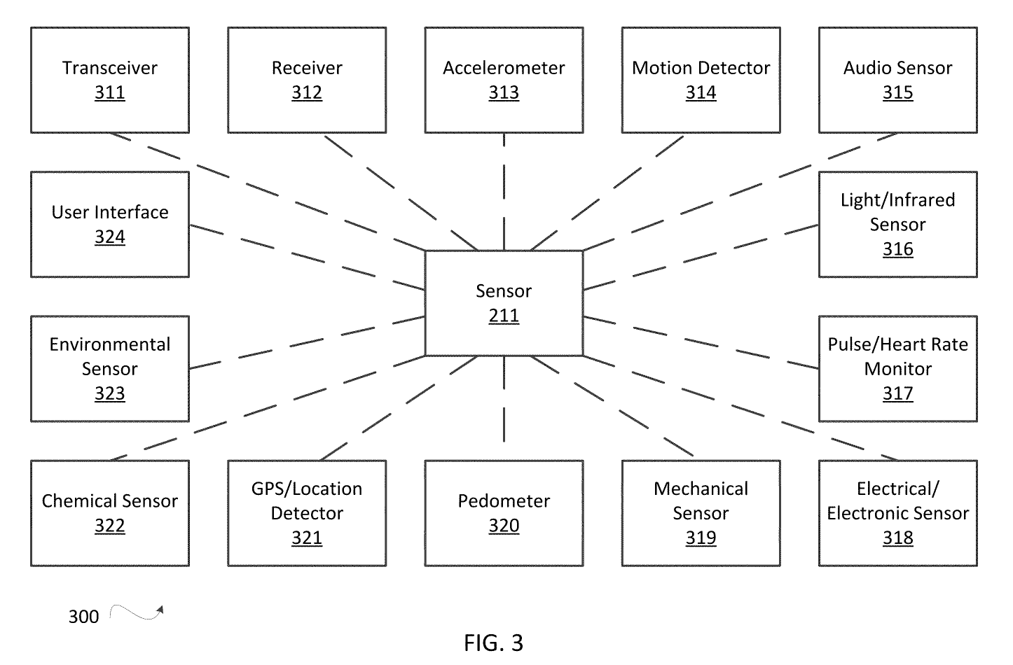

FIG. 2 illustrates an exemplary system for an inconvenience manager using sensory input of a wearable device. Here, diagram 200 includes wearable device 201, sensors 211-215, an inconvenience manager 230, a pattern library 231, moderation operation A 221, moderation operation B 222 and moderation operation C 223. Sensors 211-215, inconvenience manager 230 and pattern library 231 may be local or remote, or internal or external, to wearable device 201, and moderation operations 221-223 may be performed partially or wholly on wearable device 201 or another device in data communication with wearable device 201. As described above, wearable device 201 may be implemented as a communications device that is non-intrusive, lightweight, personal, portable, easy to carry, worn around a wrist, ankle, ear or other appendage, or attached to the body or affixed to clothing. Wearable device 201 may be a telephone, tablet, laptop, smartphone, headset, data-capable band or another device that may exchange data over a network. One or more facilities, sensing elements or sensors, both active and passive, may be implemented as part of or coupled to wearable device 201 and may be used alone, or in combination, to gather varying amounts of inputs or input signals (exemplary sensors are described in more detail in connection with FIG. 3). Types of inputs gathered include temporal, motion, temperature, lighting, sound, environmental, electrical, electronic, chemical, data manually entered using a user interface, whether another device (e.g., a headset) in data communication with wearable device 201 is set to ON, OFF or SLEEP (i.e., low power state), or others. As described above, wearable device 201 may receive an incoming call over a network. Inconvenience manager 230 may perform analyses, evaluations or other processes on the data received from the sensors to determine a pattern. A pattern may be a set of parameters of certain values indicating a called party's local time, activity (e.g., whether the user is sleeping, in a meeting, using wearable devices 102-103, entering a room), or other information associated with the incoming call. The value of the parameter may be a specific value or a threshold (e.g., higher or lower or in between certain values). For example, a pattern indicating sleep activity may be composed of one parameter, e.g. time, having a threshold value, e.g. 10 p.m. to 6 a.m. Another pattern indicating sleep may have two parameters, e.g. motion and whether a headset is ON or OFF, having certain values, e.g. reduced motion and headset is OFF, respectively. As another example, a pattern indicating a meeting may include a time of 9:00 a.m. to 5 p.m. and a moderate sound level. Further a pattern may indicate a specific time, e.g., 9:00 a.m., and this pattern may be a time of wearable device 201 having the value 9:00 a.m.

For example, a user may travel from a place located in the Eastern Time Zone (UTC-05:00) to a place located in the Pacific Time Zone (UTC-08:00) with wearable device 201. Sensor 211 of wearable device 201 may receive data representing the local time of the new time zone from a nearby cell tower or local cellular network and the time of wearable device 201 may be automatically updated, e.g., from 8:00 a.m. in the Eastern Time Zone to 5:00 a.m. in the Pacific Time Zone. Based on the local time, inconvenience manager 230 may determine that an incoming call is received at 5:00 a.m. rather than 8:00 a.m. according to the user's time zone. As another example, the local time or official time may be changed because there is a switch from daylight savings to standard time (or vice versa). Sensor 211 may receive data representing the local time in the new time standard and inconvenience manager 230 may automatically update the time of wearable device 201 and determine the time of an incoming call according to the new time standard.

As another example, sensor 212 of wearable device 201 may receive data about the user's physical motion. Inconvenience manager 230 may process the motion data to determine a called party's physical, emotional or mental state at or around the time the incoming call is received. For example, reduced movement may indicate the called party is sleeping or resting.

Sensor 213 of wearable device 201 may receive data from another device in data communication with wearable device 201, such as a headset or wearable devices 102-103 (FIG. 1), indicating whether the other device is set to ON, OFF, SLEEP or other modes. For example, inconvenience manager 230 may determine whether a headset in Bluetooth data communication with the wearable device 201 is ON or OFF at or around the time the incoming call is received.

Sensor 214 of wearable device 201 may receive data about the user's schedule or electronic calendar, such as a time period scheduled for a meeting, picking up children from school, taking a nap, having a date, attending a church service or other activities. For example, inconvenience manager 230 may determine the activity or type of activity a user is likely engaged in based on an electronic calendar of the user. The calendar may be stored in a local memory, server, intermediary or other storage device that can be directly or indirectly accessed by inconvenience manager 230 using a bus or other wired or wireless data communications. Events may be manually entered into the calendar by a user, either locally (e.g., using a keyboard or touchscreen of wearable device 201) or remotely (using a keyboard or mouse of a computer in data communication with wearable device 201). Events may also be automatically entered into the calendar by an application. For example, an email application may detect keywords in an email or email chain indicating that a meeting is agreed upon between the user and another person. The email application may automatically enter this meeting into the user's calendar.

Other sensors may be used to detect different types of inputs. For example, a sound sensor may detect a reduced sound level, which may indicate that the baby is sleeping. As another example, a GPS or other location detector may detect a geographical location of wearable device 201. Using the location, inconvenience manager 230 may determine the time zone by accessing a database, library or other data stored in a memory, local or remote to wearable device 201. These sensors and others may be used alone or in combination to determine a pattern. For example, inconvenience manager 230 may receive input from sensor 211 and sensor 212 to determine a pattern that is composed of a time between 9 a.m. and 5 p.m. and a motion level being moderate, and the pattern may indicate the user is in a meeting.

As described above, inconvenience manager 230 of wearable device 201 may determine whether the incoming call is received at a time that is inconvenient for the called party to be disturbed or otherwise notified by the incoming call. Inconvenience manager 230 is coupled to a pattern library 231. Pattern library 231 stores one or more inconvenience patterns indicating one or more periods of inconvenience. An inconvenience pattern may be a set of parameters of certain values indicating a period of inconvenience for the called party. For example, an inconvenience pattern may the parameter time having threshold values between 10 p.m. and 6 a.m. Other inconvenience patterns may be reduced motion, sleep activity, an OFF signal from a Bluetooth headset, or the duration of a meeting entered in a calendar. An inconvenience pattern may also include more than one type of input. For example, an inconvenience pattern may be composed of a meeting activity and an OFF signal from the headset.

Further an inconvenience pattern may be composed of a start triggering event and an end triggering event, indicating a period of inconvenience during the time period between the two triggering events. A triggering event may be composed of one or more parameters, each parameter having a certain change in value. For example, a triggering event may have one parameter, e.g., physical location, having a certain change in value, e.g., going from on the street to inside the home. Another triggering event may have two parameters, e.g., physical location and temperature, each having a certain change in value, e.g., going from on the street to inside the home and going from 50 degrees Fahrenheit to 68 degrees Fahrenheit. The parameters used can be any parameter received from any sensor described above. The start triggering event may depend on one or more parameters that are different from that of the end triggering event. For example, an inconvenience pattern may have a start triggering event, e.g., the user enters the office, and an end triggering event, e.g., the user begins eating lunch. This inconvenience pattern indicates that the time period between the user entering the office and the user eating lunch is a period of inconvenience of the user.

Inconvenience manager 230 may compare the pattern associated with the incoming call with one or more inconvenience patterns stored in pattern library 231. If the pattern associated with the incoming call matches an inconvenience pattern, then inconvenience manager 230 may determine that the incoming call was received during a period of inconvenience of the called party. Then inconvenience manager 230 may initiate execution of one or more of moderation operations 221-223. As described above, a moderation operation is an operation that delays, interferes, postpones, cancels, terminates or otherwise moderates or makes less disruptive the notification signal generated from an incoming call. The moderation operation may further provide a message to the caller, otherwise interact with the caller, or perform other operations. For example, rather than allowing the incoming call to directly generate a ringing of wearable device 201, inconvenience manager 230 may generate an inconvenience message notifying the calling party that the incoming call has been received in a period of inconvenience. The inconvenience message may further indicate the time of the incoming call. For example, the message may state, “You have called at a period of inconvenience. It is currently 10 p.m. at the called party's local time.” As another example, a moderation operation may provide an option to the called party to go forward with placing the call (e.g., an inconvenience message stating, “If you choose to remain on the line, the call will go through. Otherwise you may choose to hang up now and call back later”) and then after a delay cause a ringing of wearable device 201. The caller may choose to go forward with placing the call, e.g., because the caller's message is urgent or important.

Inconvenience manager 230 may not generate any notification signal of wearable device 201 to the called party while playing or providing the inconvenience message to the caller. In this case, the called party will not be able to respond to (or know of) the incoming call until the caller decides to go forward with placing the call, which may generate a ringing or other normal or more intrusive notification signal of wearable device 201 after a delay.

As another example, inconvenience manager 230 may generate a less intrusive notification signal of wearable device 201 while providing the inconvenience message to the caller. The less intrusive notification signal, e.g., may be a display on the screen of wearable device 201 while the wearable device 201 remains silent, a vibration of wearable device 201, a blinking, certain color or other indication on an LED light of wearable device 201, or a ringing by another device in data communication with wearable device 201 (e.g., headset 103 of FIG. 1). When the called party receives the less intrusive notification, the called party is provided an opportunity to pick up or otherwise respond to the incoming call. If after the inconvenience message is provided the called party does not respond (e.g., because she was not aware of the less intrusive notification signal) and the caller decides to go forward with placing the call, a ringing or other normal or more intrusive notification signal is initiated. After a certain number of rings or a certain duration of the notification signal, the moderation operation may connect the caller with the called party's voicemail or otherwise terminate the incoming call or cut off the data communication link. The modification operation may further adjust the duration of the notification signal before terminating the incoming call.

As another example, a moderation operation may further notify the calling party that a period of inconvenience has passed. The caller may decide to hang up instead of going forward with placing the call, and the caller may desire to call again when the period of inconvenience is passed. The moderation operation can generate a message notifying the caller that the period of inconvenience has passed. For example, a period of inconvenience is set before 6:00 a.m. At 6:01 a.m., a text message may be sent to the calling party stating that the period of inconvenience of the called party is over.

Different inconvenience patterns may be associated with different moderation operations. For example, an inconvenience pattern of sleep activity may be associated with moderation operation A 221, providing a message stating the called party's local time and then terminating the incoming call. As another example, an inconvenience pattern of a meeting may be associated with moderation operation B 222, providing a message stating that the called party is attending a meeting and then providing an option to the calling party to go forward with the call. As another example, an inconvenience pattern of the time period 5:00 p.m. to 6:00 p.m. may be associated with moderation operation C 223, providing a vibration of wearable device 201.

Inconvenience patterns may be pre-determined, pre-set, or have factory or default settings. For example, inconvenience manager 230 may be pre-programmed to store an inconvenience pattern indicating a period of inconvenience between 1 a.m. and 5 a.m. everyday. Inconvenience patterns may also be manually entered or determined. For example, the user may enter through a user interface the threshold times of a period of inconvenience, such as between 10 p.m. and 6 a.m. on weekdays and 11 p.m. and 8 a.m. on weekends. The user interface may be installed, fabricated or manufactured on wearable device 201, or the user interface may be on wearable devices 102-103 (FIG. 1), a laptop, another mobile device or other computer that is in direct or indirect data communication with wearable device 201. The user interface may be implemented as a button, touchscreen, keyboard, sound, light or other devices.

Further an inconvenience pattern may be automatically generated based on historic data received by one or more sensors coupled to wearable device 201. For example, inconvenience manager 230 determines that historically (e.g., for the past week), the average time the user goes to bed is 10 p.m. and the average time the user wakes up is 6 a.m. Inconvenience manager 230 may automatically generate an inconvenience pattern having a time period between 10 p.m. and 6 a.m. regardless of whether sleep activity is actually received from the sensors.

In one embodiment, inconvenience manager 230 further determines whether the calling party is exempt from the moderation operation, i.e., the incoming call made by the calling party is not subject to the moderation operation. Sensor 215 of wearable device 201 receives data representing the caller, for example, the telephone number, email, unique address, or other identity (ID) number or label of the calling party. One or more exempt callers, identified by their telephone number, email, unique address, or other identity (ID) number or label, are stored in a memory coupled to wearable device 201. The exempt callers may be stored as a list of exempt callers or as a subset of the user's phonebook or contact list that is marked as exempt or in other formats. Inconvenience manager 230 compares the data representing the caller with the one or more exempt callers. If the caller is an exempt caller, then regardless of whether the incoming call is received during a period of inconvenience, the moderation operation is not initiated or executed. If the calling party is not an exempt caller, then the inconvenience manager 230 determines whether the incoming call is received during a period of inconvenience and initiates execution of the moderation operation, as described above.

FIG. 3 illustrates sensors for use with an exemplary wearable device with an inconvenience manager. Sensors 211-215 (FIG. 2) may be implemented using various types of sensors, some of which are shown. Sensor 211 may be implemented as a transceiver 311, receiver 312, accelerometer 313, motion detector 314, audio or sound sensor 315, light or infrared sensor 316, pulse or heart rate monitor 317, electrical or electronic sensor 318, mechanical sensor 319, pedometer 320, global positioning system (GPS) or location detector 321, chemical sensor 322, environmental sensor 323, or user interface 324. Sensor 211 may be configured based on the type of sensor, firmware, software, hardware or circuitry used.

As shown, transceiver 311 may be used to capture data being transmitted to the wearable device through a data communication link or may be used to transmit data from the wearable device through a data communication link. Receiver 312 may also be used to receive data through a data communication link. For example, transceiver 311 or receiver 312 may receive data representing a local time from a nearby cell tower or other transmitter. Further transceiver 311 or receiver 312 may receive data stored in an electronic calendar or schedule saved on a server, cloud or other storage device in data communication with the wearable device. Transceiver 311 or receiver 312 may receive data using one or more data communication protocols (e.g., IEEE 802.11a/b/g/n (WiFi), WiMax, ANT™, ZigBee®, Bluetooth®, Near Field Communications (NFC), 3G, 4G, telecommunications, internet protocols, and others) through a wired, wireless, public, private, secure or other network.

Accelerometer 313 or motion detector 314 may be used to capture data associated with motion detection along 1, 2 or 3-axes of measurement, without limitation to any specific type of specification of sensor. Motion detector 314 may be configured to detect motion using a variety of techniques and technologies, including, but not limited to comparative or differential light analysis (e.g., comparing foreground and background lighting), sound monitoring, or others. Audio sensor 315 may be implemented using any type of device configured to record or capture voice or sound. Light or infrared sensor 316 may be implemented by any type of device configured to measure light or photonic conditions. Environmental sensor 323 may include any type of sensor for capturing data associated with environmental conditions such as light, temperature, altitude, humidity, sound, or pollen density.

A pulse or heart rate monitor 317 may be implemented by any type of device configured to measure pulse or heart rate, heart rate variability, breathing rate and other parameters relating to the user's fitness. Pedometer 312 may be implemented using devices to measure various types of data associated with pedestrian-oriented activities such as running or walking Footstrikes, stride length, stride length or interval, time, and other data may be measured. GPS or location detector 321 may be used to obtain coordinates of the geographic location of wearable device 101 using, for example, various types of signals transmitted by civilian and/or military satellite constellations in low, medium, or high earth orbit (e.g., “LEO,” “MEO,” or “GEO”). In other examples, differential GPS algorithms may also be implemented with GPS or location detector 321, which may be used to generate more precise or accurate coordinates. Electrical or electronic sensor 318 and mechanical sensor 319 may be configured to include other types (e.g., haptic, kinetic, piezoelectric, piezomechanical, pressure, touch, thermal, and others) of sensors for data input to wearable device 101, without limitation. Other types of sensors apart from those shown may also be used, including location-based services detectors, magnetic flux sensors such as solid-state compasses and the like, including gyroscopic sensors. While the present illustration provides numerous examples of types of sensors that may be used with wearable device 101 (FIG. 2), others not shown or described may be implemented with or as a substitute for any sensor shown or described.

Sensors (e.g., sensors 211-215 (FIG. 2) and sensors 311-324 (FIG. 3)) may be local to the wearable device (e.g., fabricated, manufactured, installed, integrated or otherwise implemented with wearable device 101 (FIG. 1)) or remote to the wearable device (e.g., a microphone on headset 103 (FIG. 1), a temperature sensor on band 102 (FIG. 1), a keyboard on a laptop, or other distributed sensors). A remote sensor may be a sensor that can be accessed, controlled or otherwise used by wearable device 101. A local sensor may be, for example, an accelerometer on wearable device 101 used to detect motion. Additionally, a sensor implemented with a screen on wearable device 101 may be used to read a user's temperature or obtain a biometric signature while a user is interacting with data. A remote sensor may be, for example, a microphone on headset 103 (FIG. 1) used to detect ambient audio data that is used to help identify a person's location, or a pulse monitor on headset 103 affixed to an ear used to detect pulse rate. Input from a remote sensor (e.g., the microphone or the pulse monitor of headset 103) may be directly or indirectly transmitted to the wearable device. A further example may include using data that is observed on a laptop or computer that provides information as to a user's online behavior and the type of content that she is viewing, which may be used by the inconvenience manager of wearable device 101. Regardless of the type or location of sensor used, data may be transferred to the wearable device by using, for example, an analog audio jack, digital adapter (e.g., USB, mini-USB), or other, without limitation, plug, or other type of connector that may be used to physically couple wearable device 101 to another device or system for transferring data and, in some examples, to provide power to recharge a battery (not shown). Alternatively, a wireless data communication interface or facility (e.g., a wireless radio that is configured to communicate data to and from wearable device 101 using one or more data communication protocols (e.g., IEEE 802.11a/b/g/n (WiFi), WiMax, ANT™, ZigBee®, Bluetooth®, Near Field Communications (NFC), 3G, 4G, telecommunications, internet protocols, and others)) may be used to receive or transfer data. Further, wearable device 101 may be configured to analyze, evaluate, modify or otherwise use data gathered, either directly or indirectly.

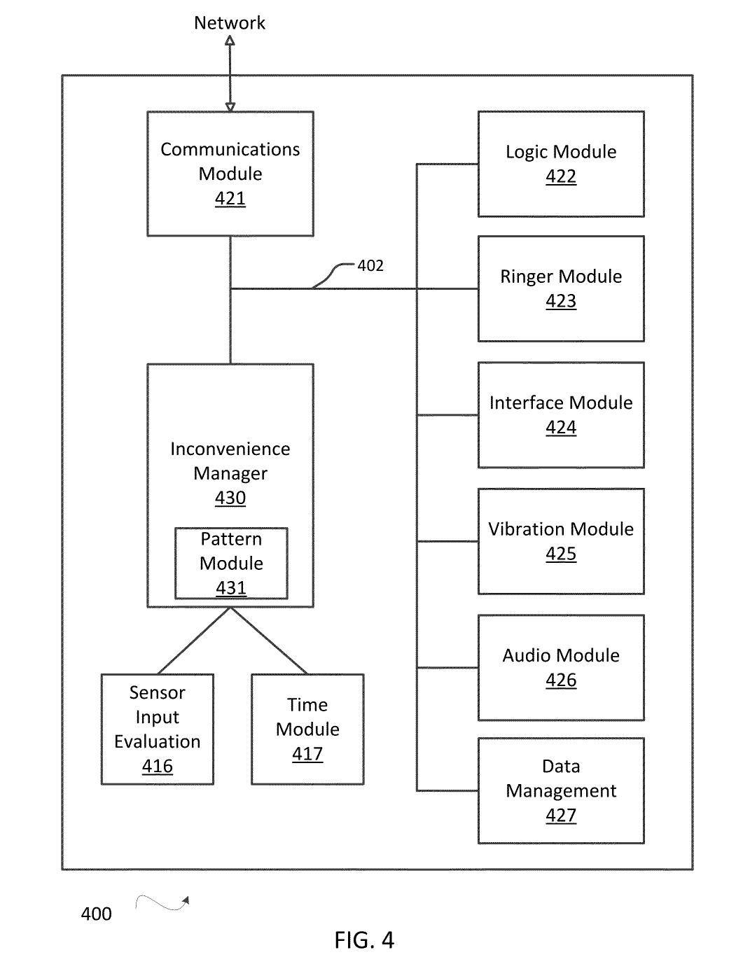

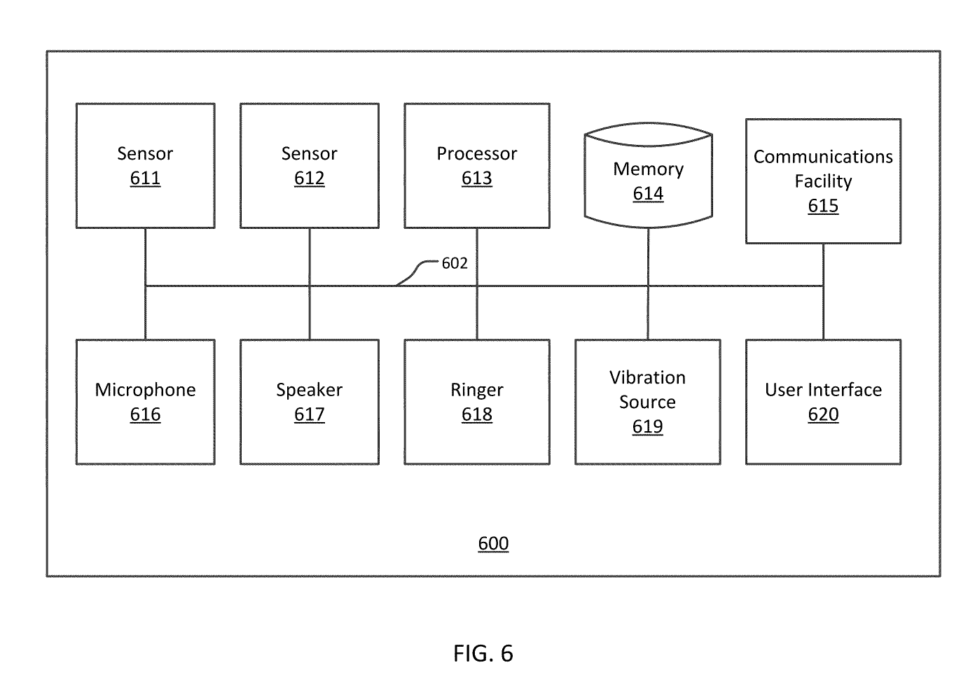

FIG. 4 illustrates an application architecture for an exemplary wearable device with an inconvenience manager. Here, application architecture 400 includes bus 402, communications module 421, logic module 422, ringer module 423, interface module 424, vibration module 425, audio module 426, data management 427, inconvenience manager 430, pattern module 431, sensor input evaluation module 416, and time module 417. In some examples, application architecture 400 and the above-listed elements (e.g., bus 402, communications module 421, logic module 422, ringer module 423, interface module 424, vibration module 425, audio module 426, data management 427, inconvenience manager 430, pattern module 431, sensor input evaluation module 416, and time module 417) may be implemented as software using various computer programming and formatting languages such as Java, C++, C, and others. As shown here, logic module 422 may be firmware or application software that is installed in memory 614 (FIG. 6) and executed by processor 613 (FIG. 6). Included with logic module 422 may be program instructions or code (e.g., source, object, binary executables, or others) that, when initiated, called, or instantiated, perform various functions.

For example, logic module 422 may be configured to send control signals to communications module 421 in order to transfer, transmit, or receive data over a network. Data representing an incoming call may be received by communications module 421. Communications module 421 may be configured to receive other types of data as well. For example, data representing a local time may be received by communications module 421. As another example, data representing a calendar or a phonebook of the user that is stored on a server, cloud or other intermediary may be received by communications module 421. As another example, data representing a location within a cellular or micro-cellular or other location-based service, which may or may not use GPS or other satellite constellations for fixing a position, may be received by communications module 406. As another example, data representing whether another device (such as headset 103 in FIG. 1) is ON or OFF may be received by communications module 421. The network may utilize any type of communications technology, wired or wireless.

Sensor input evaluation module 416 may be a firmware, software engine or module that is used to evaluate and analyze data received from one or more inputs (e.g., from sensors 211-215 and 301-324, which may be local or remote) to the wearable device. Sensor input evaluation module 416 may analyze, evaluate or process time, motion, sound, light, temperature, electrical, electronic, chemical, user-input or other data. When received, data may be analyzed by sensor input evaluation module 416, which may include custom or “off-the-shelf” analytics packages that are configured to provide application-specific analysis of data to determine trends, patterns, and other useful information. As described above, a pattern may be a set of parameters of certain values, e.g., a time range between 10 p.m. and 6 a.m. A pattern may also be a function of more than one type of input or parameter. For example, a pattern indicating sleep activity may be composed of a time between 11 p.m. and 6 a.m., reduced motion, reduced sound and reduced light. As another example, a pattern of increased motion and increased salinity (indicating sweat) may indicate physical exercise. As another example, both a current time of 9:30 a.m. and a meeting scheduled in an electronic calendar from 9 a.m. to 10 a.m. may indicate a meeting in session. Sensor input evaluation module 416 may allow for tolerances to determine whether given inputs fall within a trend or pattern. For example, a heart rate of 110 with a tolerance of +/−15 beats per minute indicates moderate physical exercise. A pattern may also comprise a set of criteria, all or only a subset of which need to be met. For example, a pattern may comprise the criteria a high level of movement, a high altitude, a high level of salinity, and a location in a park, only three of which need to be met to indicate that the user is hiking.

Pattern module 431 may be configured to compare or reference the pattern associated with the incoming call with inconvenience patterns, which may be saved in the pattern library 231 (FIG. 2). Pattern module determines whether the pattern associated with the incoming call matches one or more inconvenience patterns. For example, an inconvenience pattern may be a time period, e.g., between 10 p.m. and 6 a.m. If the time associated with an incoming call is 11 p.m., then it matches this inconvenience pattern. An inconvenience pattern may be a combination of different patterns or parameters. For example, an inconvenience pattern is when there is sleep activity and the headset is OFF. The inconvenience pattern is matched only if both patterns are matched. Alternatively, an inconvenience pattern may comprise a set of patterns or parameters, only a subset of which need to be found for the inconvenience pattern to be considered as matched. For example, an inconvenience pattern may comprise five criteria—the time is between 9 a.m. and 5 p.m., a meeting is in session, the user is speaking, and the user is standing—and only three criteria need to be met for the inconvenience pattern to be considered matched. Pattern module 431 may be implemented as part of or separate from inconvenience manager 430.

Inconvenience manager 430 may be configured to determine that the incoming call was received during a period of inconvenience for the called party and to initiate a moderation operation using logic module 422, ringer module 423, interface module 424, vibration module 425, audio module 426, data management 427, or communications module 421, or other modules not shown. If the pattern associated with the incoming call matches an inconvenience pattern, then it is determined that the incoming call was received during a period of inconvenience for the called party. Inconvenience manager 430 may send an instruction directly or indirectly to ringer module 423 to terminate or cancel any ringing of the wearable device. It may also instruct ringer module 423 to lengthen or shorten the ringing. Inconvenience manager 430 may send an instruction to interface module 424 to cause a less disruptive notification signal to be provided by the wearable device, e.g., blinking of an LED light, a message displayed on the screen of the wearable device, or others. Inconvenience manager 430 may send an instruction to vibration module 425 to generate a vibration or a vibratory pattern. Inconvenience manager 430 may also send an instruction to communications module 421 to provide a voice message to the calling party. The message may state that this is currently an inconvenient time to call the called party. The message may also provide the caller an option to go forward with placing the call. Inconvenience manager 430 may access data management module 427 to determine whether the caller is exempt from the moderation operation. Inconvenience manager 430 may also access data management module 427 to determine the time zone of a certain geographical location. Data management module may comprise a database management system (DBMS) or utility. Instructions from inconvenience manager 430 may be sent to logic module 422, which may provide further instructions to other applications or modules.

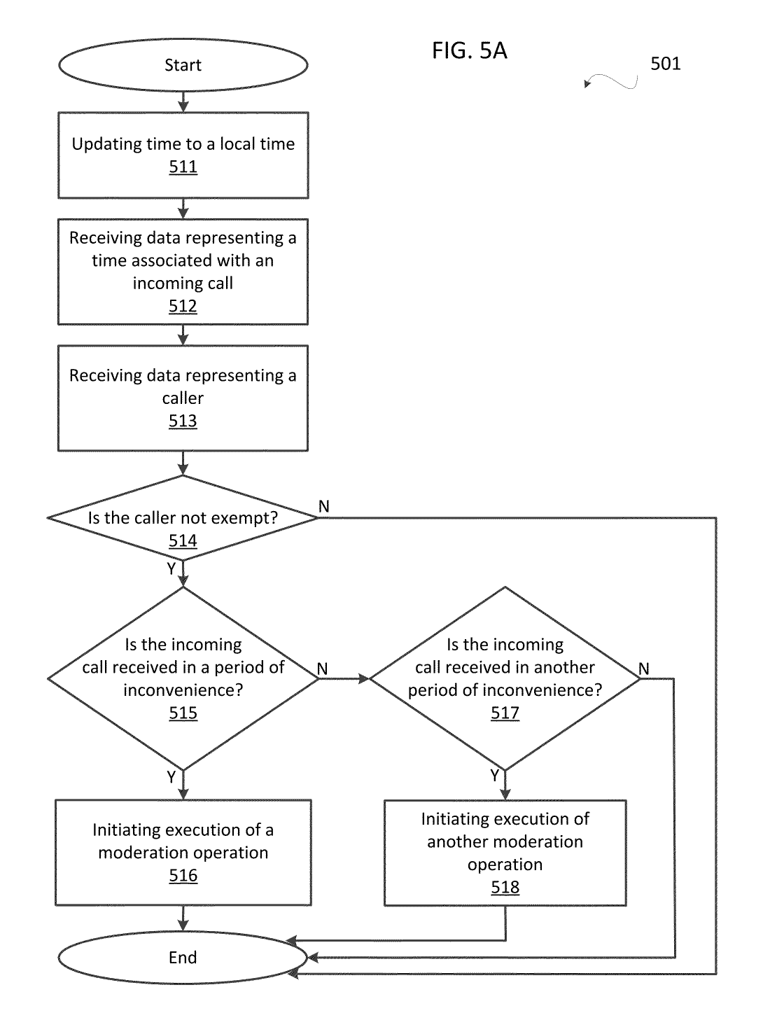

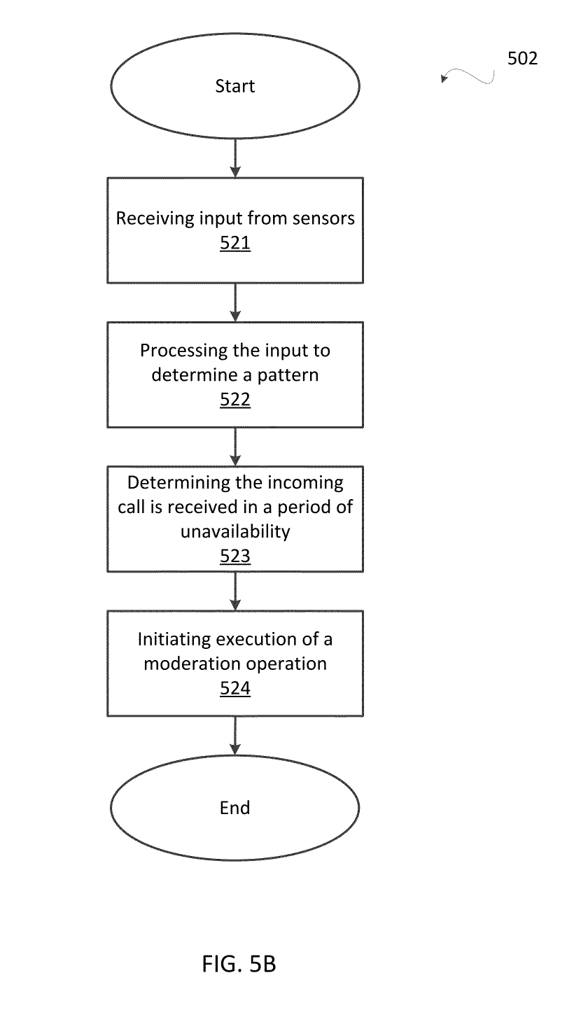

FIG. 5A illustrates an exemplary process for an inconvenience manager using a local time. Here, process 501 begins by updating a time of a wearable device to a local time (511). Data representing a time associated with an incoming call is received (512), and data representing the caller is also received (513). Then, a determination is made as to whether the caller is exempt from moderation operations (514). This can be done by referencing one or more exempt callers stored in a memory. The one or more exempt callers may be organized as a list of exempt callers, or may be a subset of contacts in a phonebook or contact list marked as exempt, or in another format or organization. If the caller is exempt, then the process 501 ends, and no moderation operation is executed. If the caller is not exempt, then a determination is made as to whether the incoming call is received in a period of inconvenience (515). This determination may be made by comparing the time associated with the incoming call with one or more threshold times indicating a period of inconvenience stored in a memory. If the incoming call is received in a period of inconvenience, then one or more control signals are generated initiating execution of a moderation operation (516). Going back to step 515, if it is determined that the incoming call is not received in a period of inconvenience, then a determination is made as to whether the incoming call is received in another period of inconvenience (517). The other period of inconvenience may be defined by parameters or patterns different from the first period of inconvenience. If the incoming call is received in the other period of inconvenience, then one or more control signals are generated initiating execution of another moderation operation (518). The other moderation operation may be the same as or different from or overlap with the first moderation operation. Going back to step 517, if the incoming call is not received in the other period of inconvenience, then the process 501 ends, and no moderation operation is executed. In other examples, additional periods of inconvenience and moderation operations may be included. In other examples, a determination as to whether the caller is exempt can be made for each moderation operation. In still other examples, process 501 and the above-described elements may be varied in order, function, detail, or other aspects, without limitation to examples provided.

FIG. 5B illustrates an exemplary process for an inconvenience manager using sensory input. Here, process 502 begins be receiving one or more inputs from one or more sensors, which may be coupled to or in data communication with a wearable device (521). Once received, the input is processed to determine a pattern (522). Using the determined pattern, a determination is made as to whether the incoming call is made in a period of inconvenience (523). This determination may be made by comparing the pattern against one or more inconvenience patterns stored in a pattern library. An inconvenience pattern indicates a period of inconvenience and may comprise sleep activity, a meeting, a television show time or any other time or activity or period during which it is inconvenient for the user to be disturbed by a notification of the incoming call. Upon finding a match between the pattern and one or more inconvenience patterns, indicating that the incoming call is received in a period of inconvenience, then a control signal is generated initiating execution of a moderation operation (524). As in process 501, additional other periods of inconvenience and other moderation operations may be included, and a determination as to whether the caller is exempt can be made for each moderation operation. In other examples, process 502 and the above-described elements may be varied in order, function, detail, or other aspects, without limitation to examples provided.

FIG. 6 illustrates a block diagram for an exemplary wearable device with an inconvenience manager. Here, wearable device 600 includes bus 602, sensors 611-612, processor 613, memory 614, communications facility 615, microphone 616, speaker 617, ringer 618, vibration source 619 and user interface 620. In some examples, the quantity, type, function, structure and configuration of wearable device 600 and the elements (e.g., bus 602, sensors 611-612, processor 613, memory 614, communications facility 615, microphone 616, speaker 617, ringer 618, vibration source 619 and user interface 620) shown may be varied and are not limited to the examples provided. As shown, processor 613 may be implemented as logic to provide control functions and signals to sensors 611-612, memory 614, communications facility 615, microphone 616, speaker 617, ringer 618, vibration source 619 and user interface 620. Processor 613 may be implemented using any type of processor or microprocessor suitable for packaging within wearable devices 101-103 (FIG. 1). Various types of microprocessors may be used to provide data processing capabilities for wearable device 600 and are not limited to any specific type or capability. Data processed by processor 613 may be stored using, for example, memory 614.

In some examples, memory 614 may be implemented using various types of data storage technologies and standards, including without limitation read-only memory (ROM), random access memory (RAM), dynamic random access memory (DRAM), static random access memory (SRAM), static/dynamic random access memory (SDRAM), magnetic random access memory (MRAM), solid state, two and three-dimensional memories, Flash® and others. Memory 614 may also be implemented using one or more partitions that are configured for multiple types of data storage technologies to allow for non-modifiable (i.e. by a user) software to be installed (e.g., firmware installed on ROM) while also providing for storage of captured data and application using, for example, RAM. Once captured and/or stored in memory 614, data may be subject to various operations performed by other elements of wearable device 600.

As shown, various sensors 611-612 may be used as input sources for data captured by wearable device 600. Sensors 611-612 may include an accelerometer to gather data measured across one, two or three axes of motion. They may also be implemented to provide temperature, environmental, physical, chemical, electrical or other types of sensed inputs. As presented here, sensors 611-612 may include one or multiple sensors and is not intended to be limiting as to the quantity or type of sensor implemented. Data captured by wearable device 600 using an accelerometer or other local or distributed sensor may also be exchanged, transferred or otherwise communicated through communications facility 615. As used herein, “facility” refers to any, some or all of the features and structures that are used to implement a given set of functions. For example, communications facility 615 may include a wireless radio, control circuit or logic, antenna, transceiver, receiver, transmitter, resistors, diodes, transistors or other elements that are used to transmit or receive data to and from wearable device 600. In some examples, communications facility 615 may be implemented to provide a wired data communication capability such as an analog or digital attachment, plug, jack, land line or the like to allow for data to be transferred. In other examples, communications facility 615 may be implemented to provide wireless data communication capability to transmit digitally encoded data across one or more frequencies using various types of data communication protocols, without limitation.

Microphone 616, in some examples, may be implemented as a dynamic microphone (using e.g. electromagnetic induction), a condenser microphone (using e.g. capacitance charge), a microphone that uses piezoelectric generation or light modulation or other technology to produce an electrical voltage signal from mechanical vibration due to sound. Microphone 616 may be implemented as a single, multiple, or array of microphones and is not intended to be limiting as to the quantity or type of microphone implemented. Speaker 617 may be implemented as a piezoelectric speaker, a ribbon or planar magnetic speaker, a digital speaker or other a speaker using other technology to produce a sound in response to an electrical signal. Speaker 617 may be implemented as a single, multiple, or array of speakers and is not intended to be limiting as to the quantity or type of speaker implemented. Microphone 616 may be used to capture or record sound, and speaker 617 may be used to provide sound. The sound may comprise voice communications between a caller and a called party. The sound may also comprise background noise and white noise. The sound may also comprise a beep, ring or other tone generated by wearable device 600 or another computer or computing device.

Ringer 618, in some examples, may be implemented as a piezoelectric speaker or other speaker to produce a sound in response to an electrical signal. The sound may comprise a beep, ring or other tone generated by wearable device 600. The sound may be used to notify the called party that there is an incoming call.

Vibration source 619, in some examples, may be implemented as a motor or other mechanical structure that functions to provide vibratory energy that is communicated through wearable device 600. As an example, an inconvenience manager module stored on memory 614 may be configured to generate a control signal instructing vibration source 619 to provide a vibration upon determining that an incoming call is received during a period of inconvenience. As another example, vibration source 619 may be coupled to a framework (not shown) or other structure that is used to translate or communicate vibratory energy throughout the physical structure of wearable device 600. In other examples, vibration source 619 may be implemented differently.

User interface 620 may be implemented as a touchscreen, keyboard, mouse, joystick, LED light, display screen or other device used to serve as an interface between wearable device 600 and the user. User interface 620 may be used to generate a LED light to notify the caller of an incoming call. User interface 620 may also be used to receive data manually entered by the user. The data entered using user interface 620 may be used to specify or customize an inconvenience pattern. For example, a user may specify that for an inconvenience pattern indicating sleep activity, the moderation operation is providing an inconvenience message to the caller that the incoming call was received during a period of inconvenience. As another example, a user may customize an off-the-shelf inconvenience pattern indicating the time period between 1 a.m. and 5 a.m., modifying the moderation operation such that it provides a vibration rather than a blinking light. In some examples, user interface 620 may also serve as a sensor. For example, a touchscreen may be used to detect the temperature of a user's figure. In still other examples, wearable device 600 and the above-described elements may be varied in function, structure, configuration or implementation and are not limited to those shown or described.

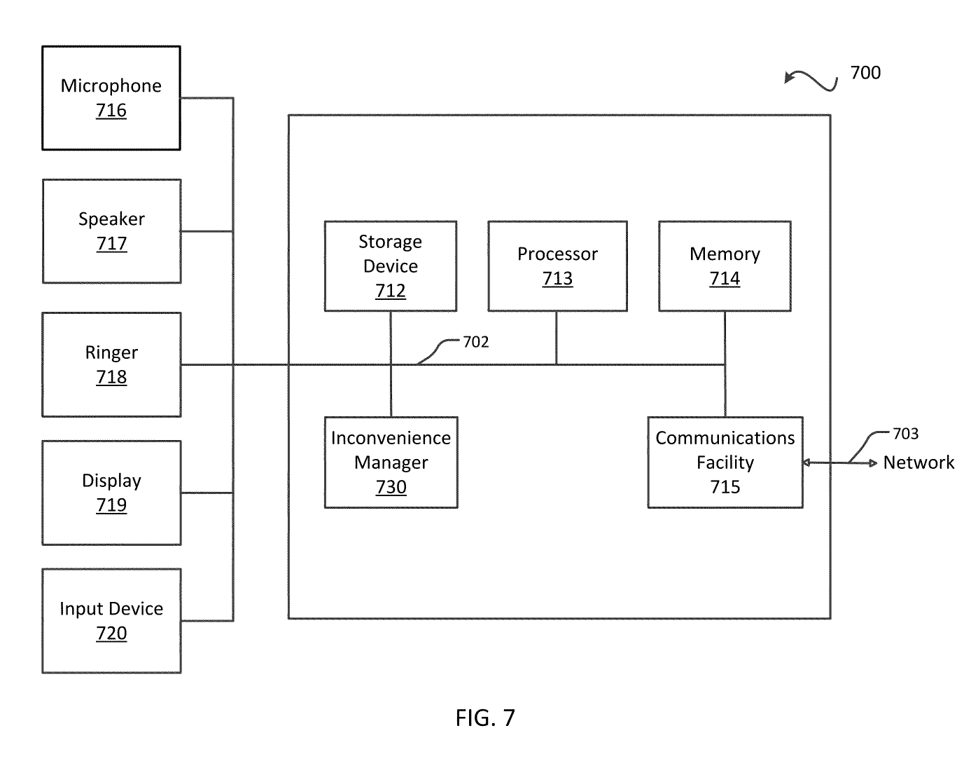

FIG. 7 illustrates an exemplary computer system suitable for use with an inconvenience manager. In some examples, computer system 700 may be used to implement computer programs, applications, methods, processes, or other software to perform the above-described techniques. Computer system 700 includes a bus 702 or other communication mechanism for communicating information, which interconnects subsystems and devices, such as processor 713, storage device 712 and memory 714 (e.g., ROM, RAM, magnetic or optical drives), communications facility 715 (e.g., modem or Ethernet card), microphone 716, speaker 717, ringer 718, display 719 (e.g., CRT or LCD), input device 720 (e.g., keyboard, mouse or touchscreen), and inconvenience manager 730.

According to some examples, computer system 700 performs specific operations by processor 713 executing one or more sequences of one or more instructions stored in memory 714. Such instructions may be read into memory 714 from another computer readable medium, such as storage device 712. In some examples, hard-wired circuitry may be used in place of or in combination with software instructions for implementation. Inconvenience manager 730 may be implemented as part of or separate from processor 713, and inconvenience manager 730 may be stored partially or wholly on memory 714 or storage device 712 or another medium.

The term “computer readable medium” refers to any tangible medium that participates in providing instructions to processor 713 for execution. Such a medium may take many forms, including but not limited to, non-volatile media and volatile media. Non-volatile media includes, for example, optical or magnetic disks. Volatile media includes dynamic memory.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 702 for transmitting a computer data signal.

In some examples, execution of the sequences of instructions may be performed by a single computer system 700. According to some examples, two or more computer systems 700 coupled by communication link 703 (e.g., LAN, PSTN, or wireless network) may perform the sequence of instructions in coordination with one another. Computer system 700 may transmit and receive messages, data, and instructions, including program, i.e., application code, through communication link 703 and communication facility 715. Received program code may be executed by processor 713 as it is received, and/or stored in storage device 712 or memory 714, or other non-volatile storage for later execution.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method, comprising:
updating a time of a wearable device to a local time;
receiving data representing a time associated with an incoming call to the wearable device;
determining the incoming call is received in a period of inconvenience by comparing the data representing the time associated with the incoming call against data representing one or more threshold times indicating the period of inconvenience stored in a memory; and
initiating execution of a moderation operation associated with the period of inconvenience to modify an operation of the wearable device.

2. The method of claim 1, further comprising determining whether the incoming call is received in another period of inconvenience by comparing the data representing the time associated with the incoming call against data representing one or more other threshold times indicating the another period of inconvenience stored in the memory, the another period of inconvenience associated with another moderation operation.

3. The method of claim 1, wherein the moderation operation comprises generating a message indicating the time associated with the incoming call.

4. The method of claim 1, wherein the moderation operation comprises transmitting a signal indicating the period of inconvenience is terminated after the period of inconvenience is terminated.

5. The method of claim 1, wherein the moderation operation comprises:
generating a delay; and
generating a ringing after the delay.

6. The method of claim 1, wherein the moderation operation comprises:
determining whether to generate a ringing after a delay;
generating a vibration during the delay;
generating the ringing after the delay; and
adjusting a duration of the ringing before terminating the incoming call.

7. The method of claim 1, wherein the moderation operation comprises causing a vibratory source to generate a vibration.

8. The method of claim 1, further comprising:
receiving data representing a caller; and
determining the caller is not exempt from the moderation operation by comparing the data representing the caller with data representing one or more exempt callers stored in the memory.

9. The method of claim 1, wherein the one or more threshold times are manually determined.

10. The method of claim 1, further comprising receiving data representing the local time from a cellular network.

11. A method, comprising:
receiving one or more inputs from one or more sensors coupled to the wearable device, the one or more inputs comprising data representing a local time;
determining pattern data associated with an incoming call based on the one or more inputs, the pattern data indicating an activity;
determining the incoming call is received in a period of inconvenience by comparing the pattern data against data representing one or more inconvenience patterns indicating the period of inconvenience stored in a memory; and
initiating execution of a moderation operation associated with the period of inconvenience to modify an operation of the wearable device.

12. The method of claim 11, wherein the one or more sensors comprise an accelerometer and the one or more inputs further comprise motion data.

13. The method of claim 11, wherein the one or more inputs further comprise an on/off signal associated with a device in data communication with the wearable device.

14. The method of claim 11, wherein the one or more inputs further comprise calendar data.

15. The method of claim 11, wherein the incoming call is transmitted via a telecommunications network.

16. The method of claim 11, wherein the pattern data comprises data representing sleep activity.

17. The method of claim 11, wherein the one or more inconvenience patterns comprise data representing meeting activity.

18. The method of claim 11, wherein the one or more inconvenience patterns comprise data representing a start triggering event and data representing an end triggering event, wherein the period of inconvenience indicated by the one or more inconvenience patterns is a time period between the start triggering event and the end triggering event.

19. The method of claim 11, wherein the one or more inconvenience patterns are generated from historic data representing sleep activity.

20. A system, comprising:
a memory configured to store one or more inputs associated with an incoming call to a wearable device received from one or more sensors coupled to the wearable device and to store data representing one or more inconvenience patterns indicating a period of inconvenience;
a processor configured to determine a pattern data based on the one or more inputs, the pattern data comprising data representing an activity and data representing a time, to determine the incoming call is received in the period of inconvenience by comparing the pattern data against the data representing the one or more inconvenience patterns, and to initiate execution of a moderation operation associated with the period of inconvenience to modify an operation of the wearable device.
